(19) United States
(12) Patent Application Publication
(10) Pub. No.: US 2004/0077786 A1
(43) Pub. Date: Apr. 22, 2004

(54) Oxygen absorbent films and structures comprising same

(76) Inventors: Patrice Robert, Serquigny (FR); Jean-Jacques Flat, Serquigny (FR)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/276,708

(22) PCT Filed: May 15, 2001
(86) PCT No.: PCT/FR01/01472

(30) Foreign Application Priority Data
May 17, 2000 (FR) 00/06284

(51) Int. Cl. C08L 51/04; C08G 63/48; B32B 27/38

(52) U.S. Cl. 525/71; 428/413; 525/326.1

(57) ABSTRACT

The present invention relates to a film comprising copolymers of ethylene and of an unsaturated epoxide and comprising quinones grafted onto these copolymers. The quinones are subsequently reduced (activation) to become oxygen absorbers.

According to an advantageous form of the invention, it is possible, in addition to the quinones, to graft a product which results in the appearance of a hydroxyl functional group (proton donor) and optionally introduces other hydroxyl functional groups. This improves the activation of the quinone functional groups.

The present invention also relates to structures comprising at least one barrier film to oxygen and at least the preceding film.

The present invention also relates to a packaging comprising the preceding structure, in which, starting from the inside of the packaging and proceeding towards the outside, first the oxygen-absorbing film is encountered, followed by the barrier film to oxygen.

### FIELD OF THE INVENTION

The present invention relates to an oxygen-absorbing film and more particularly to a film of polyolefins comprising grafted quinones and also relates to a packaging comprising such a film.

Numerous foodstuffs decompose on contact with atmospheric oxygen. This is why use is made of packagings generally composed of a multilayer structure to preserve them during their transportation and their distribution until they are consumed. This structure comprises a film of a polymer which forms a barrier to oxygen, such as EVOH (copolymer of ethylene and of vinyl alcohol or saponified copolymer of ethylene and of vinyl acetate) or polyamides. However, a small amount of air always enters before the packaging is closed.

It is not always possible to create a vacuum. Furthermore, foods with porous structures can comprise air, which it is difficult to remove, even by creating a vacuum.

Structures have been developed comprising a barrier film and an oxygen-absorbing film which are positioned so that the barrier film is on the outside and the oxygen-absorbing film is on the inside of the packaging.

The inside of the packaging defines the surface of the packaging in contact with the food which it comprises and the outside of the packaging defines the surface of the packaging in direct contact with the surrounding air.

In fact, these structures also comprise other films, for example of polyethylene or of polypropylene, which provide for the mechanical strength of the structures and their protection against water.

The polyolefin film of the present invention comprising grafted quinones is an oxygen-absorbing film of use in the technology described above. The invention also relates to a structure comprising one or more oxygen-absorbing films and one or more barrier films.

### THE PRIOR ART

Patent applications WO 94 12590, WO 96 34070 and WO 99 10251 disclose the technology set out above in the field of the invention and more particularly the oxygen-absorbing film and its operation. This technology consists in introducing anthraquinone (AQ) molecules into a polymer film. The operating principle of this system is broken down into 3 stages:

Activation:

The quinone molecules are reduced to hydroquinone molecules under UV irradiation, the necessary protons being provided by proton donors present in the polymer. This activation is carried out after the manufacture of the packaging and thus it is not necessary to manufacture this film under an inert atmosphere.

Absorption:

The oxygen present inside the packaging and the small amounts of O₂ which might cross the barrier film react with the hydroquinones obtained in the preceding stage. The reaction results in the production of quinone and of hydrogen peroxide H₂O₂.

Destruction of H₂O₂:

This is carried out by a reducing agent present in the polymer. The amount of this reducing agent can be adjusted so as not to destroy all the H₂O₂, so as to leave a sufficient amount thereof to produce a bactericidal effect.

In the examples of these prior arts, the constituents of the oxygen-absorbing film are the following polymers:

blends of polymer with oxygen-absorbing molecules; these are not grafted polyolefins, that is to say that there is no chemical bond between the absorbing molecule and the polymer.

copolymers of styrene, of 2-hydroxyethyl methacrylate and of vinylanthraquinone.

EVOHs grafted by an anthraquinone which is functionalized with an acid chloride.

Ethylene-acrylic acid copolymers which have reacted with bromoethylanthraquinone to give ethyleneanthraquinone acrylate copolymers.

### THE TECHNICAL PROBLEM

Blends of molecules of the anthraquinone type with polymers are not easy to prepare and the copolymerization of these molecules of the anthraquinone type with other monomers is rendered difficult because of the high melting point of these molecules. Graftings by quinones carrying acid chloride groups or brominated groups are expensive because these functional groups are complicated to prepare and because the grafting generates brominated or chlorinated byproducts which are difficult to remove.

The Applicant Company has now found that quinones can be grafted onto polymers carrying epoxide groups and that they can be very easily converted into a film, it being possible for this film to be used as oxygen absorber in the abovementioned structures.

### BRIEF DESCRIPTION OF THE INVENTION

The present invention relates to a film comprising copolymers of ethylene and of an unsaturated epoxide and comprising quinones grafted onto these copolymers. The advantage of these films is that they can be easily manufactured and that the quinones which are grafted onto the copolymers are easy to manufacture. Another advantage is that these films can be activated by simple passing under UV radiation, without it being necessary to add a proton donor to the film.

According to a first advantageous form of the invention, it is possible, in addition to the quinones, to graft a product which results in the appearance of a hydroxyl functional group (proton donor) and optionally introduces other hydroxyl functional groups. This improves the activation of the quinone functional groups.

According to a second advantageous form of the invention, the polymer comprising grafted quinones can be blended with a polymer comprising hydroxyl functional groups and then converted into a film. These last two forms can also be combined.

The present invention also relates to a structure comprising at least one barrier film to oxygen and at least the preceding oxygen-absorbing film.

The present invention also relates to a packaging comprising the preceding structure, in which, starting from the inside of the packaging and proceeding towards the outside, first the oxygen-absorbing film is encountered, followed by the barrier film to oxygen.

### DETAILED DESCRIPTION OF THE INVENTION

The copolymers of ethylene and of an unsaturated epoxide can be polyethylenes (A) grafted by an unsaturated epoxide (B) or copolymers (C) of ethylene and of an unsaturated epoxide (B) which are obtained, for example, by radical polymerization.

Mention may be made, as examples of unsaturated epoxides (B) to be grafted or to be copolymerized, of:

aliphatic glycidyl esters and ethers, such as allyl glycidyl ether, glycidyl vinyl ether, glycidyl maleate, glycidyl itaconate or glycidyl (meth)acrylate, and

alicyclic glycidyl esters and ethers, such as 2-cyclohexen-1-yl glycidyl ether, diglycidyl cyclohexene-4,5-dicarboxylate, glycidyl cyclohexene-4-carboxylate, glycidyl 5-norbornene-2-methyl-2-carboxylate and diglycidyl endo-cisbicyclo[2.2.1]hept-5-ene-2,3-dicarboxylate.

As regards the polyethylenes (A) onto which the unsaturated epoxide (B) is grafted, the term “polyethylene” is understood to mean homo- or copolymers.

Mention may be made, as comonomers, of:

α-olefins, advantageously those having from 3 to 30 carbon atoms; mention may be made, as examples of α-olefins, of propylene, 1-butene, 1-pentene, 3-methyl-1-butene, 1-hexene, 4-methyl-1-pentene, 3-methyl-1-pentene, 1-octene, 1-decene, 1-dodecene, 1-tetradecene, 1-hexadecene, 1-octadecene, 1-icosene, 1-docosene, 1-tetracosene,-1-hexacosene, 1-octacosene and 1-triacontene; these α-olefins can be used alone or as a mixture of two or of more than two,

esters of unsaturated carboxylic acids, such as, for example, alkyl (meth)acrylates, it being possible for the alkyls to have up to 24 carbon atoms; examples of alkyl acrylate or methacrylate are in particular methyl methacrylate, ethyl acrylate, n-butyl acrylate, isobutyl acrylate and 2-ethylhexyl acrylate,

vinyl esters of saturated carboxylic acids, such as, for example, vinyl acetate-or propionate,

dienes, such as, for example, 1,4-hexadiene.

The polyethylene can comprise several of the preceding comonomers.

The polyethylene, which can be a blend of several polymers, advantageously comprises at least 50% and preferably 75% (in moles) of ethylene; its density can be between 0.86 and 0.98 g/cm³. The MFI (viscosity index at 190° C., 2.16 kg) is advantageously between 0.1 and 1 000 g/10 min.

Mention may be made, as examples of polyethylenes, of:

low density polyethylene (LDPE)

high density polyethylene (HDPE)

linear low density polyethylene (LLDPE)

very low density polyethylene (VLDPE)

polyethylene obtained by metallocene catalysis, that is to say the polymers obtained by copolymerization of ethylene and of α-olefin, such as propylene, butene, hexene or octene, in the presence of a single-site catalyst generally composed of a zirconium or titanium atom and of two cyclic alkyl molecules bonded to the metal. More specifically, the metallocene catalysts are usually composed of two cyclopentadiene rings bonded to the metal. These catalysts are frequently used with aluminoxanes as cocatalysts or activators, preferably methylaluminoxane (MAO). Hafnium can also be used as metal to which the cyclopentadiene is attached. Other metallocenes can include transition metals from Groups IVA, VA and VIA. Metals from the lanthanide series can also be used.

EPR (ethylene/propylene rubber) elastomers

EPDM (ethylene/propylene/diene) elastomers

Blends of polyethylene with an EPR or an EPDM

ethylene/alkyl (meth)acrylate copolymers which can comprise up to 60% by weight of alkyl (meth)acrylate and preferably 2 to 40% by weight.

The grafting is an operation known per se.

As regards the copolymers (C) of ethylene and of the unsaturated epoxide (B), they are copolymers of ethylene, of the unsaturated epoxide and optionally of another monomer which can be chosen from the comonomers which were mentioned above for the-ethylene copolymers intended to be grafted.

The copolymers (C) of ethylene and of an unsaturated epoxide are advantageously ethylene/alkyl (meth)acrylate/unsaturated epoxide copolymers obtained by copolymerization of the monomers and not by grafting the unsaturated epoxide onto the polyethylene. They comprise from 0 to 40% by weight of alkyl (meth)acrylate, preferably 5 to 35%, and up to 10% by weight of unsaturated epoxide, preferably 0.1 to 8%.

The unsaturated epoxide (B) to be copolymerized is advantageously glycidyl (meth)acrylate.

The alkyl (meth)acrylate is advantageously chosen from methyl (meth)acrylate, ethyl acrylate, n-butyl acrylate, isobutyl acrylate or 2-ethylhexyl acrylate. The amount of alkyl (meth)acrylate is advantageously from 20 to 35%. The MFI is advantageously between 5 and 100 (in g/10 min at 190° C. under 2.16 kg) and the melting temperature is between 60 and 110° C.

As regards the quinones which will be grafted onto the preceding copolymers, mention may be made, as examples, of benzoquinone, anthraquinone and naphthoquinone. The quinone carries a functional group capable of reacting with the epoxide group of the copolymer. Mention may be made, as examples, of carboxylic acids, salts of carboxylic acids, dicarboxylic acid anhydrides, alcohols and amines. Carboxylic acids are preferred. The functionalized quinones are solids at ambient temperature. They are powdered and then they are added to the preceding copolymers, in the molten state, while carrying out intimate blending. The device in which this intimate blending is carried out can be any piece of equipment used for the blending of thermoplastics, such as a single- or twin-screw extruder, a blender or a Buss® Ko-Kneader. The functionalized quinones are added to these blending devices using hoppers or any device for introducing powders. The particle size of these powders can be highly variable. The finer it is, the more homogeneous the incorporation of these powders in the polymer melt. It is advantageously at most 200 μm and preferably between 10 and 150 μm.

The copolymer in the molten state comprising the grafted quinones can be conveyed to a device for converting it into a film or cooled and recovered in the form of granules to be subsequently converted into a film, like the majority of thermoplastics. The thickness of the film can be between 10 and 300 μm and preferably between 15 and 150 μm.

The proportion of functionalized quinone to be used is one quinone per epoxide functional group. As regards carboxylated anthraquinone (AQ), its grafting onto the copolymer of ethylene and of an unsaturated epoxide (glycidyl methacrylate) can be represented by the following equation:

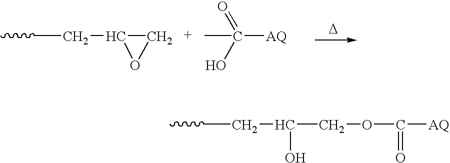

in which “AQ” denotes the anthraquinone.

The quinone functional groups can subsequently be activated but it is recommended only to do it when the packaging is closed or ready to be closed. This activation can be carried out by exposure to UV radiation or any wavelength appropriate to the quinones used or by heat, gamma rays, a corona discharge or a beam of electrons. The film can also comprise an agent for destroying the H₂O₂ formed, such as, for example, a triphenylphosphine, a triphenyl phosphite, triethyl phosphite, triisopropyl phosphite, tris(nonylphenyl) phosphite, tris(mono- and bisnonylphenyl) phosphite, butylhydroxytoluene, butylhydroxyanisole, tris(2,4-di(tert-butyl)phenyl) phosphite, dilauryl thiodipropionate, 2,2′-methylenebis(6-t-butyl-p-cresol), tetrakis(2,4-di(tert-butyl)phenyl)-4,4′-biphenyldiphosphonite, poly(4-vinylpyridine) or their mixtures.

According to a first advantageous form of the invention, an acid R₁—COOH, in which R₁ denotes any group other than a quinone which can carry one or more hydroxyl functional groups, is grafted onto the copolymer of ethylene and of an unsaturated epoxide, in addition to the quinones. The reaction takes place as follows:

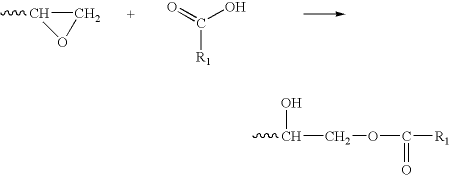

R₁ advantageously denotes an alkyl, cycloalkyl or aromatic radical which can carry one or more hydroxyl functional groups. The conditions are similar to those of the grafting of the quinones and even easier when R₁—COOH is liquid.

The quinone and then R₁—COOH can be grafted successively or in reverse order or alternatively simultaneously. R₁—COOH is preferably the product with the following formula, which is known as DMPA (abbreviation for DiMethylolPropionic Acid):

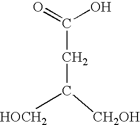

The greater the amount of R₁—COOH, the more effective the activation of the quinones. It is the same when the number of hydroxyl functional groups carried by R₁ increases. To increase the amount of quinones and of R₁—COOH attached to the copolymer, it is sufficient to choose a copolymer having a higher proportion of epoxy functional groups.

According to a second advantageous form of the invention, the copolymer comprising the grafted quinones is blended with a polymer comprising hydroxyl functional groups. The latter can be; for example, EVOH or a polymer of the following formula (1) in which R₁—COOH has the same meaning as above:

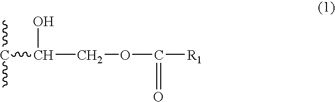

This polymer (1) can be obtained by reaction of the copolymer (2) represented below with the reactant R₁—COOH.

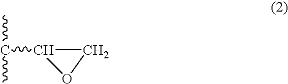

According to an advantageous form of the invention, the copolymer (2) is a copolymer of ethylene and of an unsaturated epoxide.

Mention may be made, as examples of copolymer (2), of polyolefins, polystyrene, PMMA, polyamides, fluoropolymers, polycarbonate, saturated polyesters, such as PET or PBT, thermoplastic polyurethanes (TPU) and polyketones, all these polymers being grafted by an unsaturated epoxide, such as, for example, glycidyl (meth)acrylate.

According to an advantageous form of the invention, the copolymer (2) is chosen from copolymers of ethylene and of an unsaturated epoxide. These copolymers have been described above.

As regards the reaction of the copolymer (2) with the reactant R₁—COOH, it is carried out in a similar way to the grafting of the carboxylated quinones, as is explained above.

As regards the multilayer structure comprising at least one barrier film to oxygen and at least the preceding oxygen-absorbing film, the barrier film is advantageously made of EVOH, of polyamide, of polyketone or of PVDF. This structure advantageously also comprises one or more polyolefin films for strengthening the structure and for protection against water. If the barrier film is made of EVOH, the structure advantageously comprises a film made of polyolefin, such as polyethylene or polypropylene, on each side of the barrier film. This is because EVOH is sensitive to moisture and loses its oxygen-barrier property in the presence of moisture. Advantageously, the structure of the invention thus successively comprises: a polyolefin film, an EVOH film, a polyolefin film and the film comprising the grafted quinones as oxygen absorber with thicknesses advantageously (in the same order in μm): 10 to 100/5 to 20/10 to 100/15 to 150.

According to another form of the invention, the structure additionally comprises a polyolefin film, the oxygen-absorbing film being thus sandwiched between two polyolefin films. As polyolefins are highly permeable to oxygen, this polyolefin film thus does not hinder the reaction of oxygen with the reduced quinones.

It would not be departing from the scope of the invention to position a binder, such as a coextrusion binder, between the preceding layers.

These structures can be manufactured by the usual techniques for multilayer films, such as cast or blown coextrusion or by extrusion coating.

The present invention also relates to a packaging comprising the preceding structure. It can be formed by the structure, which is closed by any means over itself to prepare sachets or-bags therefrom. The structures of the invention may only be a portion of the packaging, for example the film which closes off a punnet. This punnet is advantageously made of a barrier material but does not comprise an oxygen-absorbing film, the oxygen absorber included in the film for closing off the punnet being sufficient. Once the packaging has been closed, the quinones are activated by reduction by passing under a UV lamp or any equivalent means.

### EXAMPLES

### Example 1

### Grafting of 2-carboxyanthraquinone onto Lotader AX 8840® in a Twin-Screw Extruder

Lotader AX 8840 is an ethylene/glycidyl methacrylate (MA) random copolymer comprising 80% by weight of MA and having an MFI of 4 (at 190° C. under 2.16 kg).

2-Carboxyanthraquinone, of expanded formula:

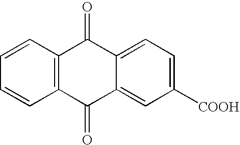

This compound is provided in the form of a yellow powder and has a melting point of 288° C.

The grafting is carried out in the molten state in a Leistritz® laboratory rotating twin-screw extruder.

The thermal profile of the extruder is set at 20° C. The Lotader® is introduced into the feed hopper in the first region of the extruder using a weight metering device. The 2-carboxyanthraquinone is introduced in the powder form using another metering device. The proportions used are: 88% Lotader AX 8840®/12% 2-carboxyanthraquinone. The reactive extrusion of the blend of the 2 components is carried out at a throughput of 6 kg/h and at a rotational speed of the screws of 50 revolutions/min. The grafted product is extruded in the form of a stick, which is cooled in a water tank and then granulated after passing into a granulator.

The product obtained has a melt index (MFI), measured at 190° C. under 2.16 kg, of 2.

Analysis by infrared spectroscopy shows the disappearance of the epoxy functional groups and the appearance of the OH functional groups.

The product was subsequently extruded in the form of a 100 μm film using a cast film extruder supplied by Scamia®. The film is completely transparent and exhibits a light “coppery” colour.

### Example 2

### Grafting of 2-carboxyanthraquinone onto Lotader AX 8900®

Lotader AX 8900® is an ethylene/methyl acrylate/glycidyl methacrylate (GMA) random terpolymer comprising 8% by weight of GMA and 28% by weight of methyl acrylate and having an MFI of 6 (at 190° C. under 2.16 kg).

The grafting is carried out in the molten state in a blender, the Brabender® laboratory internal mixer.

The temperature of the body of the blender was set at 220° C.

The Lotader AX 8900® and the 2-carboxyanthraquinone are introduced into the chamber of the blender and the reactants are blended for 4 min. The proportions used are: 96% Lotader AX 8900/4% 2-carboxyanthraquinone. The rotational speed of the blades is set at 50 rev/min.

The product is subsequently formed under a press to give a 200 μm film.

### Example 3

### Activation of the Product of Example 2 by Photoreduction under UV Radiation

A 0.6 g sample of the film prepared in Example 2 was activated by passing under a laboratory UV rig of Minicure type equipped with a mercury lamp.

The irradiation time of the film was 12 s.

### Example 4

### Measurement of the Oxygen-Absorbing Properties

The activated film of Example 3 was subsequently placed in a cell comprising oxygen. The decrease in the amount of oxygen gas was monitored over time by gas chromatography:

volume of oxygen absorbed after 5 h: 4 ml

### Example 5

### Cografting of 2-carboxyanthraquinone and of DMPA onto Lotader AX 8840

The grafting is carried out in the molten state in a blender, a Brabender® laboratory internal mixer.

The temperature of the body of the blender was set at 220° C.

The Lotader AX 8840®, the 2-carboxyanthraquinone and the DMPA are introduced into the chamber of the blender and the reactants are blended for 4 min. The proportions used are: 91% Lotader AX 8840/6% 2-carboxyanthraquinone/3% DMPA. The rotational speed of the blades is set at 50 rev/min.

The product was characterized by NMR and infrared.

The product is subsequently formed under a press to give a 200 μm film.

1. Oxygen-absorbing film comprising copolymers (C) of ethylene and of an unsaturated epoxide (B), the said copolymers being grafted by quinones.

2. Film according to claim 1, in which the copolymers (C) of ethylene and of an unsaturated epoxide (B) are advantageously ethylene/alkyl (meth)acrylate/unsaturated epoxide copolymers obtained by copolymerization of the said monomers and comprise from 0-to 40% by weight of alkyl (meth)acrylate and up to 10% by weight of unsaturated epoxide.

3. Film according to claim 1 or 2, in which the grafted quinones are chosen from the group consisting of benzoquinone, anthraquinone and naphthoquinone, the said quinones comprising a functional group capable of reacting with the epoxide group of the unsaturated epoxide.

4. Film according to claim 3, in which the quinones carry a carboxylic acid functional group.

5. Film according to any one of the preceding claims, onto which an acid R₁—COOH, in which R₁ denotes any group other than a quinone which can carry one or more hydroxyl functional groups, is grafted.

6. Film according to claim 5, in which R₁ denotes an alkyl, cycloalkyl or aromatic radical.

7. Film according to claim 6, in which R₁—COOH is DMPA with the following formula:

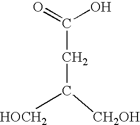

8. Film according to any one of the preceding claims, comprising (i) the copolymer comprising the grafted quinones and optionally the R₁ groups and (ii) a copolymer comprising OH functional groups.

9. Film according to claim 8, in which the copolymer comprising the OH functional groups is EVOH or a copolymer of formula (1):

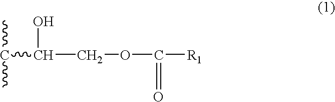

10. Structure comprising at least one barrier film to oxygen and at least one oxygen-absorbing film according to any one of the preceding claims.

11. Structure according to claim 10, in which the barrier film to oxygen is made of EVOH, of polyamide, of polyketone or of PVDF.

12. Structure according to claim 11, successively comprising: a polyolefin film, an EVOH film, a polyolefin film and an oxygen-absorbing film according to any one of the preceding claims.

13. Packaging comprising the structure according to any one of claims 10 to 12, in which, starting from the inside of the packaging and proceeding towards the outside, first the oxygen-absorbing film according to any one of the preceding claims is encountered, followed by the barrier film to oxygen.
